(19) United States
(12) Patent Application Publication
(10) Pub. No.: US 2007/0036668 A1
(43) Pub. Date: Feb. 15, 2007

(54) Scroll compressor discharge port improvements

(75) Inventors: Alexander Lifson, Manlius, NY (US); James William Bush, Skaneateles, NY (US)

Correspondence Address: CARLSON, GASKEY & OLDS, P.C., 400 WEST MAPLE ROAD, SUITE 350, BIRMINGHAM, MI, 48009, US

(73) Assignee: Carrier Corporation

(21) Appl. No.: 11/200,364

(22) Filed: Aug. 9, 2005

(51) Int. Cl. F01C 1/02; F04C 2/00; F04C 18/00; F01C 1/063; F03C 4/00

(52) U.S. Cl. 418/55.2; 418/55.1

(57) ABSTRACT

A scroll compressor is provided with a recess to increase the flow area through which compression chambers communicate with a discharge port. The scroll compressor is of the sort having a wrap with a swing radius that is always equal to or greater than zero. That is, this invention does not apply to the type of scroll compressor wherein a swing radius will cross zero as the wrap is generated. Stated another way, a forward ledge of the scroll compressor can be defined spaced towards a tip of the scroll wrap relative to a rear ledge. The present invention provides a recess in the type of scroll wrap wherein the forward ledge has a thickness that is at least equal to or greater than the thickness of the scroll wrap at the rear ledge. A supplemental recess may be provided in the non-orbiting scroll wrap. The recess in the orbiting scroll may be stepped to have different height portions.

### BACKGROUND OF THE INVENTION

This application relates to a scroll compressor having an inner wrap configuration wherein a swing radius is always equal to or greater than zero, and wherein the wrap is provided with a recess to increase the flow area through which the compression chambers and the discharge port communicate.

Scroll compressors are becoming widely utilized in refrigerant compression applications. A scroll compressor consists of a non-orbiting and an orbiting scroll each having interfitting wraps. The orbiting scroll moves relative to the non-orbiting scroll to move compression chambers towards a discharge port.

Much effort has gone into the design of the scroll wraps. Originally, scroll wraps were configured as relatively thin spiral wraps of a single thickness. More recently, scroll wraps of varying thickness having a shape generally defined by sequential segments of varying forms have been developed. These wraps may be generally described as “hybrid.”

The general configuration of a scroll compressor can be seen in FIG. 1A. As known, the scroll compressor 10 incorporates an orbiting scroll 12 and a non-orbiting scroll 14. These scroll members 12, 14 each have wraps.

An inner end of three known scroll wraps is illustrated in FIGS. 1B-1D. One type of scroll wrap 28 is disclosed in detail in U.S. Pat. No. 6,120,268. In this scroll compressor, a swing radius (Rₛ) begins on one side of zero, and crosses zero to move onto the other side of zero as one moves through the wrap angle. Again, this feature is described in greater detail in the above-referenced United States patent application. Another way of describing the configuration of this wrap tip 28 would be to describe ledges 29 and 31 as shown in FIG. 1B. One could say that there is a forward ledge 31 and a rear ledge 29, with the forward ledge defining a thinner portion of the wrap and the rear ledge defining a thicker portion of the wrap (A<B). The rear ledge of one of the wraps is in contact with the forward ledge of the other of the wraps at the end of a compression cycle. This configuration allows compression chambers defined on both sides of the non-orbiting and orbiting scroll wraps to open approximately equally.

Another known scroll compressor wrap inner tip wrap 30 is illustrated in FIG. 1C. In this wrap, the swing radius begins at zero and remains equal to or greater than zero. The ledges 29 and 31 generally have the same thickness (A=B).

Yet another known style wrap inner tip is illustrated in FIG. 1D. This wrap 32 has its swing radius always being greater than zero. In addition, the thickness of the forward ledge 31 is greater than the thickness of the rear ledge 29 (A>B).

These three wrap types, and in particular the swing radius as the wrap angle changes, are illustrated on FIG. 1E.

FIG. 2 shows another prior art compressor type, which has been utilized only with the FIG. 1B configuration. In this configuration, a recess 40 is provided in the orbiting scroll wrap 28a to increase the flow area through which the compression chambers communicate with a discharge port 42. However, this feature has never been incorporated into the types of scroll wraps shown in FIG. 1C or FIG. 1D. The present invention is directed to providing such a recess into the FIG. 1C and FIG. 1D wrap configurations.

### SUMMARY OF THE INVENTION

In a disclosed embodiment of this invention, scroll wraps having a swing radius that is always equal to or greater than zero, are provided with a recess adjacent the tip of the scroll wrap. The recess does not extend through the entire height of the wrap, and serves to increase the flow area through which the discharge port communicates with the compression chambers.

In other embodiments, the recess may be provided with a supplemental recess in the non-orbiting scroll. This supplemental recess may extend through the entire length of the scroll wrap of the non-orbiting scroll, or may only be formed near the top surface opposite the base of the non-orbiting scroll. This recess in the non-orbiting scroll may actually extend through the base of the non-orbiting scroll and may serve to increase the overall cross-sectional area of the discharge port.

In yet another embodiment, at least one of the recesses may have multiple steps of differing heights. This will provide benefits as described below.

These and other features of the present invention can be best understood from the following specification and drawings, the following of which is a brief description.

### BRIEF DESCRIPTION OF THE DRAWINGS

FIG. 1A shows a prior art scroll compressor.

FIG. 1B shows one wrap configuration of the prior art.

FIG. 1C shows yet another wrap configuration known in the prior art.

FIG. 1D shows yet another wrap configuration known in the prior art.

FIG. 1E graphically shows features of the wraps shown in FIGS. 1B-D.

FIG. 2 shows a prior art scroll wrap pair configuration.

FIG. 3 shows a first embodiment of the present invention.

FIG. 4 shows another embodiment of the present invention.

FIG. 5 shows another embodiment of the present invention.

### DETAILED DESCRIPTION OF THE PREFERRED EMBODIMENT

As shown in FIG. 3, a wrap 50 is provided with a recess 52 adjacent an inner tip. The recess extends downwardly to a floor 54, such that the recess 52 has a height h that is less than an overall height of the wrap. This recess 52 is preferably formed in the orbiting scroll wrap.

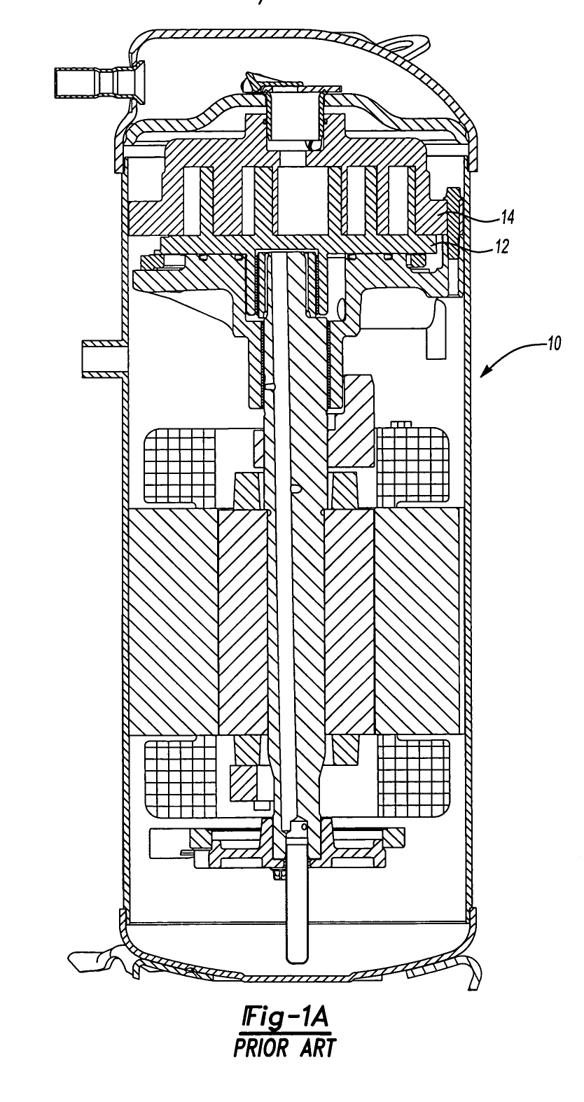

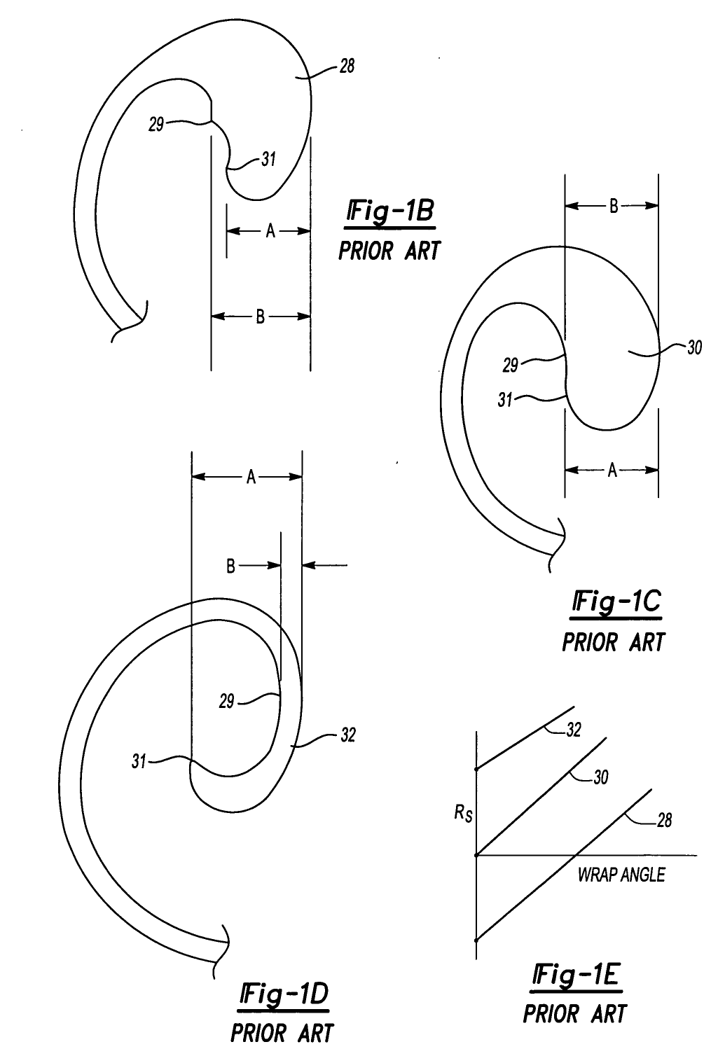

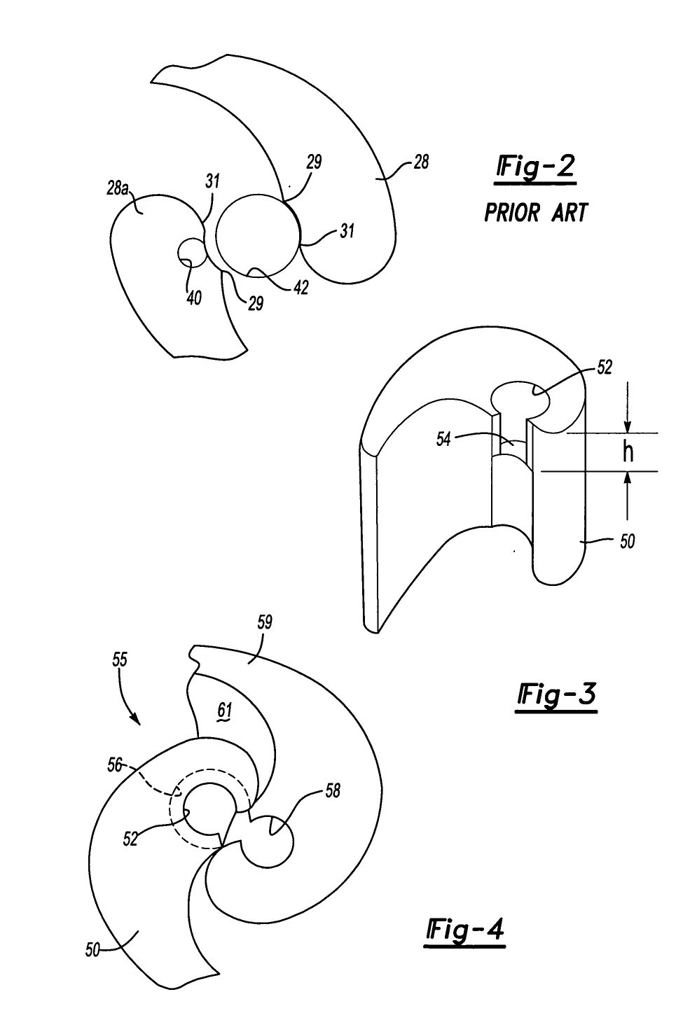

This recess will serve to increase the flow area through which the compression chambers communicate with a discharge port in the non-orbiting scroll. The wrap 50 may be configured as shown in FIG. 1C or FIG. 1D. That is the wrap 50 may have a swing radius that begins at zero and increases, or that begins above zero and remains above zero. Stated another way, a forward ledge and a rear ledge may be equal, or the forward ledge may be greater than the rear ledge in the orbiting scroll wrap 50 that incorporates the recess 52.

FIG. 4 shows another embodiment 55, wherein the discharge port 56 communicates with the recess 52. As can be appreciated from this Figure, without the recess 52, the wrap 50 would be somewhat obscuring flow through the port 56. Thus, by providing the recess 52, the amount of flow area through which the compression chambers can communicate with the port 56 is increased.

In the FIG. 4 embodiment, another recess 58 may be included in the non-orbiting scroll wrap 59. This recess 58 may extend through the base 61 of the non-orbiting scroll member, such that it is actually an increase to the cross-sectional area of the port 56.

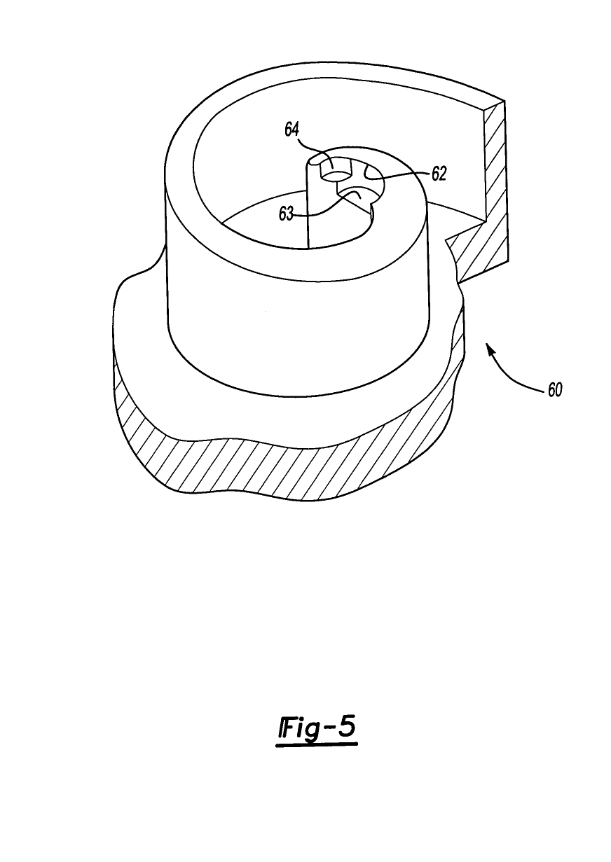

FIG. 5 shows yet another embodiment 60, wherein the recess 62 in an orbiting scroll has steps 63 and 64. The steps provide benefits such as limiting the stress and reducing clearance volume that may occur to the wrap 60 by forming a recess through a single greater height. That is, by having a stepped recess with a lower height portion 64, the scroll wrap will have lower stress adjacent its innermost end and have smaller clearance volume, yet still have the increased exposure to the discharge port benefits as described above.

While preferred embodiments of this invention have been disclosed, a worker of ordinary skill in the art would recognize that certain modifications would come within the scope of this invention. For that reason, the following claims should be studied to determine the true scope and content of this invention.

What is claimed is:

1. A scroll compressor comprising:
a non-orbiting scroll having a base and a generally spiral wrap extending from said base, said wrap having a tip adjacent a center of said non-orbiting scroll wrap;
an orbiting scroll having a base and generally spiral wrap extending from said base, said orbiting scroll having a tip adjacent the center of said orbiting scroll, said orbiting and non-orbiting scroll wraps interfitting to define compression chambers;
said tip of both of said non-orbiting and orbiting scroll wraps having an inner surface facing the opposed wrap configured to have a forward ledge adjacent said tip and a rear ledge spaced from said forward ledge in a direction away from a forwardmost end of said tip, said forward ledge defining a portion of said wrap having a thickness at least equal to a thickness of a portion of said wrap at said rear ledge; and
a recess extending into said tip of said orbiting scroll wrap, said recess extending into said tip from an end remote from said base, and through a height that is less than an entire height of said wrap.

2. The scroll compressor as recited in claim 1, wherein the thickness of said portion adjacent said forward ledge is equal to the thickness of said portion adjacent said rear ledge.

3. The scroll compressor as recited in claim 1, wherein the thickness of said portion adjacent said forward ledge is greater than the thickness of said portion of said scroll wrap adjacent said rear ledge.

4. The scroll compressor as recited in claim 1, wherein a second recess is formed in said tip of said non-orbiting scroll wrap.

5. The scroll compressor as recited in claim 4, wherein said recess in said non-orbiting scroll wrap extends through said base of said non-orbiting scroll wrap to increase a cross-sectional area of a discharge port.

6. The scroll compressor as recited in claim 1, wherein said recess includes a plurality of steps, with said steps extending into said scroll wrap for differing heights.

7. A scroll compressor comprising:
a non-orbiting scroll having a base and a generally spiral wrap extending from said base, said wrap having a tip adjacent a center of said non-orbiting scroll wrap;
an orbiting scroll having a base and generally spiral wrap extending from said base, said orbiting scroll having a tip adjacent the center of said orbiting scroll, said orbiting and non-orbiting scroll wraps interfitting to define compression chambers; and
said non-orbiting and orbiting scroll wraps being configured such that a swing radius beginning at an initial point is greater than or equal to zero, and does not cross zero as one moves through a wrap angle to define said wrap, and wherein a recess is defined extending into an end of said orbiting scroll at said tip, said recess extending into said scroll wrap for a height that is less than an overall height of said wrap.

8. The scroll compressor as recited in claim 7, wherein said swing radius is initially equal to zero, and extends on only one side of zero through the generation of the scroll wrap.

9. The scroll compressor as recited in claim 7, wherein the swing radius is initially on one side of zero, and stays on that side of zero throughout the generation of the wrap.

10. The scroll compressor as recited in claim 7, wherein a second recess is formed in said tip of said non-orbiting scroll wrap.

11. The scroll compressor as recited in claim 10, wherein said recess in said non-orbiting scroll wrap extends through said base of said non-orbiting scroll wrap to increase the cross-sectional area of a discharge port.

12. The scroll compressor as recited in claim 7, wherein said recess includes a plurality of steps, with said steps extending into said scroll wrap for differing heights.
